(19) United States
(12) Patent Application Publication
(10) Pub. No.: US 2009/0282789 A1
(43) Pub. Date: Nov. 19, 2009

(54) DEVICE FOR CONTROLLING ANIMALS

(76) Inventor: Zoe Bartron, Virginia Beach, VA (US)

Correspondence Address: DUNCAN G. BYERS PC, 142 W. York Street, Suite 910, NORFOLK, VA, 23510, US

(21) Appl. No.: 12/120,081

(22) Filed: May 13, 2008

(51) Int. Cl. B68B 1/06

(52) U.S. Cl. 54/8

(57) ABSTRACT

An improved bit for controlling a horse. The mouthpiece of the horse bit comprises extensions for applying pressure to the interior of an animal's mouth. A trained animal will respond to the applied pressure as actuated by the rider via the reins.

### BACKGROUND OF THE INVENTION

The fundamental purpose of a bit is to create pressure on or around a horse's mouth. The various known designs of horse bits provide pressure to a horse's mouth (and hence control of the animal) at various points and with varying amounts of pressure in response to a rider's signals through the reins. A horse consists of two basic components; the mouthpiece, which rests within a horse's mouth, and the attachment point(s) for the bridle and reins. Popular bits have attachment point(s) that are either rings, as in what is commonly referred as a “snaffle” bit, or shanks for a “curb” bit.

In general, snaffle bits provide direct 1:1 pressure in response to a rider's signals, while curb bits amplify the pressure through the use of the leverage provided by the shank. The mouthpiece of a bit may be single jointed, double-jointed, a straight bar (referred to as a “mullen”), or may be constructed with an arch, while the design of the mouthpiece can also be smooth, roughened or of twisted wire or metal.

Bits are designed to work by pressure, not pain. Depending on the style of bit, pressure can be brought to bear on the mouthpiece extensions, tongue, and roof of the mouth, as well as the lips, chin groove and poll. Bits offer varying degrees of control and communication between rider and horse depending upon their design and on the skill of the rider. It is important that the style of bit is appropriate to the horse's needs and is fitted properly for it to function properly and be as comfortable as possible for the horse. Although there are numerous variations, most bits fall generally into two categories: snaffle bits and curb bits. Snaffle bits provide direct, unamplified leverage to a horse's mouth. Curb bits, on the other hand, utilize a shank and purchase at the point of attachment of the reins in order to amplify the pressure created by motion or pulling of the reins. The amplification of the leverage causes greater movement on the mouthpiece and, hence, greater pressure on and within a horse's mouth to convey commands to the horse.

Because the mouthpiece of a bit rests inside of a horse's mouth, the mouthpiece can provide the most control but can also be responsible for the physical severity of the bit on the horse. And, those prior designs noted above rely upon designs that provide pressure on the roof of the mouth of a horse, with the pressure being applied in the central portion of the mouth. However, while a horse is being guided, changes in pressure on the horse's mouth need to occur in such a manner as to indicate to the horse directions for changes in speed, forward and reverse motion, and lateral direction as well. Exaggerated motions and pressure will be required for a modified bit that creates pressure in the center of a horse's mouth.

In the wrong hands even the mildest bit can hurt the horse. Conversely, a very severe bit, in the right hands, can transmit extremely subtle, nuanced signals that cause no pain to the horse. It is generally desired that slight movements of the hands should be used to communicate commands to a horse. Under the right circumstances, a skilled rider should be able to direct a horse simply by changing his or her grip on the reins, instead of pulling or jerking the horse's head to change direction by force.

What is needed, therefore, is a device that allows for slight pressure on the reins and bit to correspond to clear direction to the horse regarding a rider's direction. The device should allow for such fine control while placing as little pressure on the horse's mouth as possible, not just to create a finer degree of control over the animal, but also to provide less risk of damage to the soft tissues of a horse's mouth.

### SUMMARY OF THE PRESENT INVENTION

Because control of the horse may depend significantly upon the manner and amount of pressure applied within a horse's mouth numerous designs have attempted to increase control of a horse through modifications to the mouthpiece of a bit. For example, a “rocker arm” is added to the mouthpiece of a snaffle bit in U.S. Pat. No. 2,512,244, issued Jun. 20, 1950 to De Wolfe. Similar modifications appear in other patents and applications: U.S. Pat. No. 2,488,977, issued Nov. 22, 1959 to Johnson; U.S. Pat. No. 3,831,345, issued Aug. 27, 1974 to Stubblefield, U.S. Pat. No. 4,587,797 issued May 13, 1986 to Conrad; U.S. Pat. No. 6,105,346, issued Aug. 22, 2000 to Hsi-Chang; U.S. Pat. No. 6,761,018, issued Jul. 13, 2004 to Balding; U.S. Pat. No. 6,834,482, issued Dec. 28, 2004 to Collins, III; and U.S. App. No. 2003/0074869, filed Apr. 24, 2003 by Balding.

Each of those patents and applications, however, only provides pressure within a horse's mouth from a central point, creating a lack of fine control.

The present invention provides not only the ability to control a horse with lighter pressure, it also provides the ability to have finer and more directed control of a horse. The pressure on one side of the bit to direct a horse in that direction is translated predominantly to the post located on that side of the mouthpiece, allowing the horse to discern slight pressure differentials and thereby respond more easily to a rider's direction. In addition, the present invention significantly reduces the need for exaggerated motions and pressure to control a horse, even with an animal that can be difficult to control. The present invention may comprise a mouthpiece modification to a snaffle bit, a curb bit, or other bit types wherein greater sensitivity and control are desirable.

It is therefore an object of the present invention to provide an improved means for controlling an animal.

It is a further object of the present invention to provide an improved horsebit which requires less force to control an animal.

It is a further object of the present invention to provide an improved horsebit which reduces damage to an animal's mouth.

### BRIEF DESCRIPTION OF THE DRAWINGS

FIG. 1 shows a perspective view of the present invention.

FIG. 2 shows a top view of the present invention.

FIG. 3 shows a side view of the present invention.

### DESCRIPTION OF A PREFERRED EMBODIMENT

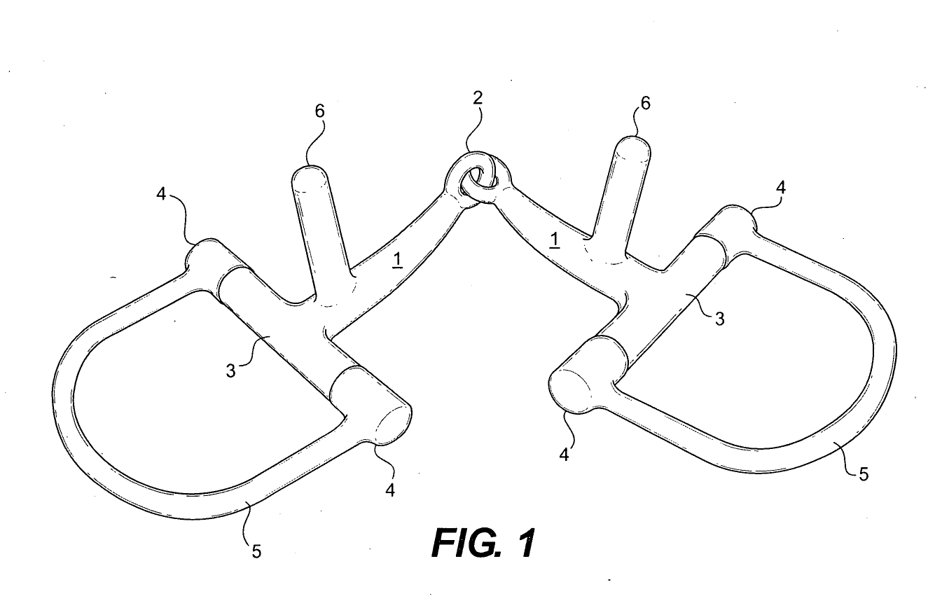

Referring now to FIG. 1, a perspective view of the present invention is shown. The invention as shown is a direct pressure ‘snaffle’ bit design with a mouthpiece 1 with a single joint 2 and bit rings 5, the bit rings connected to the mouthpiece 1 via a hinge mechanism 3 and 4. The mouthpiece 1 portion of the bit rests within a horse's mouth. Extending perpendicular to the mouthpiece 1 are mouthpiece extensions 6. The mouthpiece extensions 6, when placed in a horse's mouth, are oriented to be horizontal relative to the line of the teeth. Although the mouthpiece extensions as shown are generally linear, it is contemplated that the mouthpiece extensions 6 may be curved or other shape and still function as intended within the scope of this invention. The extensions may be comprised of the same material as the mouthpiece or may be comprised of a different material. The extensions may also further comprise a covering, such as leather or rubber, that absorbs pressure thereby reducing strain on the horse's mouth.

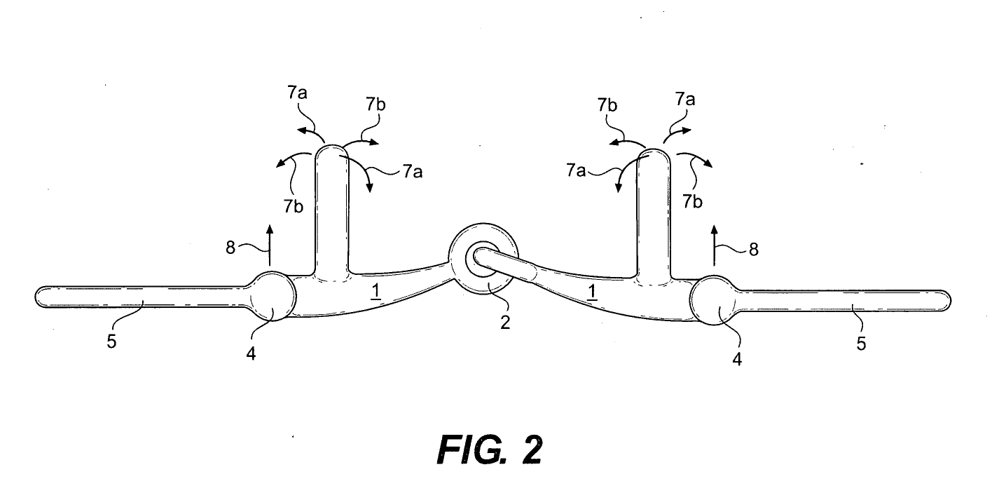

Referring now to FIG. 2, a top view of the invention is shown. Reins are attached at various points on the rings 5, and pressure is applied to the rings 5 and thence the mouthpiece 1 when the reins are pulled in a generally rearward direction 8. Motion transmitted to the mouthpiece 1 causes the mouthpiece extensions 6 to move as shown generally by 7a-7b.

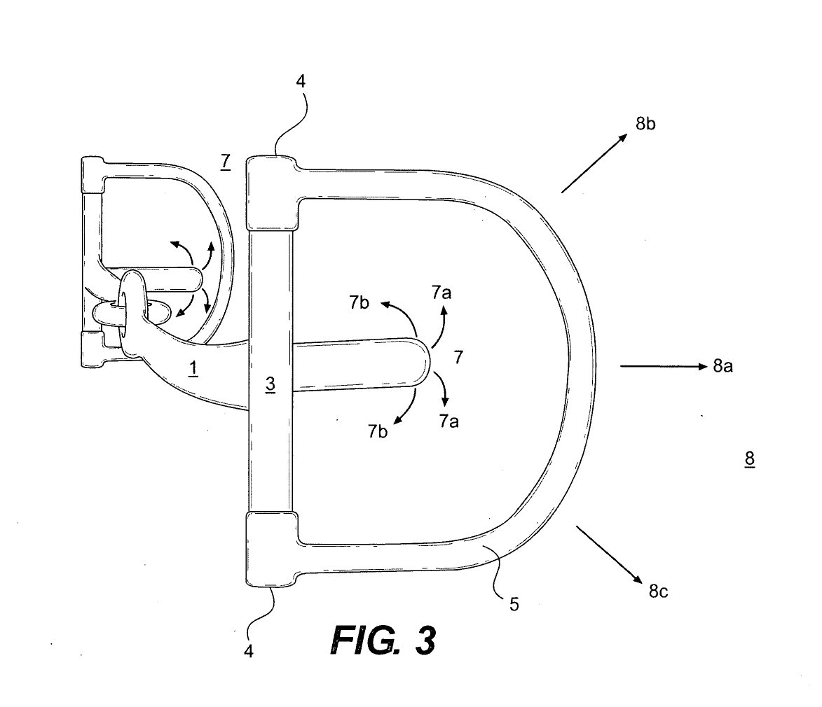

As shown in FIG. 3, the motion shown by 7a occurs when force is applied that is, at least in part, vertical (i.e., upward or downward) in relation to the horizontal plane of a horse's mouth. The motion shown by 7b occurs when force is applied parallel to the horizontal plane of a horse's mouth. As the reins are pulled to the rear, a rearward force 8a is applied to one or both of the rings 5, resulting in the movement of the mouthpiece extensions 6 as shown in 7b. Force may also be applied to the rings 5 that comprises, in part, either an upward force 8b or a downward force 8c. The amount of movement and degree of force (7a-7b) exerted on the horse's mouth by the mouthpiece extensions 6 will vary depending upon the response desired by the rider; greater force on one side of the bit in comparison to the other side will create greater movement and force exerted within the horse's mouth by the bar 6 closest to the ring 5 upon which the greater force is applied. This difference in movement and force on the mouthpiece extensions 6 allows the horse to better discern a rider's intent, reducing the force that a rider must impart on the bit to control the horse.

It will be understood that the description provided herein is merely illustrative, and should not be considered limiting. In particular, it will be understood that the present invention may utilize any shape or design of bit and/or mouthpiece. It will be further understood that the present invention may utilize various commonly utilized materials for the construction of the bit and mouthpiece, including metallic and non-metallic materials, either individually or in combination.

1-19. (canceled)

20. A device for controlling animals, which comprises:
(a) a mouthpiece;
(b) one or more rein attachment means operably connected to the mouthpiece;
(c) a means for applying pressure to the interior of an animal's mouth, wherein the means for applying pressure comprise a plurality of mouthpiece extensions, the mouthpiece extensions positioned generally perpendicular to the mouthpiece.

21. The device of claim 20, wherein the mouthpiece extensions are generally linear.

22. The device of claim 20, wherein the mouthpiece extensions comprise dual arcuate extensions.

23. The device of claim 20, wherein the mouthpiece extensions are attached at an angle in relation to the horizontal plane of mouthpiece.

24. The device of claim 20, wherein the mouthpiece extensions are constructed of a metallic material.

25. The device of claim 20, wherein the mouthpiece extensions are constructed of a non-metallic material.

26. The device of claim 20 wherein the device for controlling animals is chosen from the group comprising snaffle bits and curb bits.

27. The device of claim 20, wherein the mouthpiece extensions are positioned relative to the mouthpiece such that the mouthpiece extensions rest within in an animal's mouth between the animal's cheek and the animal's teeth.

28. The device of claim 20, wherein the mouthpiece extensions are positioned relative to the mouthpiece such that the mouthpiece extensions rest within an animal's mouth inside of the space defined by the teeth of the animal.

29. The device of claim 20, wherein the mouthpiece extensions are positioned such that when the device is actuated the extensions move relative to the direction of force applied to the device.

30. The device of claim 20, wherein the mouthpiece extensions are positioned such that when the device is actuated the mouthpiece extensions move generally perpendicular to the horizontal plane of the mouthpiece.

31. The device of claim 20, wherein the mouthpiece extensions are positioned such that when the device is actuated the mouthpiece extensions move generally within the horizontal plane of the mouthpiece.

32. The device of claim 20, wherein the mouthpiece further comprises one or more hinge means.

33. The device of claim 20, wherein the mouthpiece comprises a plurality of separately mobile portions that may be actuated individually or in concert.

34. The device of claim 20, wherein the means for applying pressure further comprises a pressure absorbing covering whereby softening the force applied to the mouth of an animal.
